(19) United States
(12) Patent Application Publication
(10) Pub. No.: US 2018/0191856 A1
(43) Pub. Date: Jul. 5, 2018

(54) CROSS-DOMAIN COMMUNICATION METHODS AND PROXY SERVERS USING THE SAME

(71) Applicant: Synology Inc., Taipei (TW)

(72) Inventors: Jen-Yao CHANG, Taipei (TW); Zuo-Rong YANG, Taipei (TW)

(21) Appl. No.: 15/798,575

(22) Filed: Oct. 31, 2017

Related U.S. Application Data
(60) Provisional application No. 62/439,931, filed on Dec. 29, 2016.

(30) Foreign Application Priority Data
Jul. 5, 2017 (CN) 201710541603.6

(51) Int. Cl. H04L 29/08; H04L 29/06; H04L 29/12; G06F 17/30

(52) U.S. Cl. CPC H04L 67/2814; H04L 67/02; H04L 67/42; H04L 63/0281; H04L 61/2517; G06F 17/30861; H04L 61/1511

(57) ABSTRACT

A proxy connected to a terminal device in a public network and to two servers in a private network is provided. The first server has a first domain name identifiable in the private network and a predetermined domain name identifiable in the public network, and the second server has a second domain name identifiable in the private network. When receiving an access request from the terminal device, which was sent from the predetermined domain name to the second domain name, the proxy replaces the predetermined domain name with the first domain name and forwards the access request to the second server. When receiving an access response from the second server, which was sent from the second domain name to the first domain name, the proxy replaces the first domain name with the predetermined domain name and forwards the access response to the terminal device.

### CROSS REFERENCE TO RELATED APPLICATIONS

This Application claims priority of U.S. Provisional Application No. 62/439,931, filed on Dec. 29, 2016, the entirety of which is incorporated by reference herein. Also, this Application claims priority of China Application No. 201710541603.6, filed on Jul. 5, 2017, the entirety of which is incorporated by reference herein.

### BACKGROUND OF THE APPLICATION

### Field of the Application

The application relates generally to proxy technologies for proxy servers, and more particularly, to a proxy server capable of solving the problems caused during cross-domain communications.

### Description of the Related Art

In typical network planning, proxy servers are commonly adopted and disposed between internal networks (also called private networks) and external networks (also called public networks) to control the communications therebetween, so as to enhance privacy and security of network terminal devices. For example, when a network terminal device in a public network requests to access a web server in a private network, the proxy server forwards the web access request received from the network terminal device to the web server and then forwards the web information provided by the web server to the network terminal device. In addition, the proxy server replaces the domain name of the web server with a virtual or predetermined domain name. As shown in FIG. 1, the real domain name of the web server A is “domain-a.com”, but the network terminal device in the public network recognizes the domain name of the web server A to be “domain-c.com” which is manipulated by the proxy server.

With the disposition of a proxy server between the private network and the public network, the network terminal device in the public network and the web server in the private network cannot communicate directly with each other. Advantageously, the web server in the private network is able to hide its Internet Protocol (IP) address from any device in the public network, thereby avoiding network attacks from the public network and being free of any content filtering attempts. In response, the network terminal device in the public network is unable to identify or access the web server in the private network.

However, there are cross-domain communications during which the domain name of a requesting server in the private network is replaced by the proxy server with a predetermined domain name. As a result, the receiving server of the cross-domain communications may reject the access request and the cross-domain communications may not be successful, due to the receiving server not being able to identify the predetermined domain name.

In a common scenario, the network terminal device in the public network loads a web page provided by a web server in the private network, and the web page further initiates an access request to another server. For example, the web page provided by a web server A may include contents, such as Cascading Style Sheets (CSS), advertisements, or images, which need to be obtained from a server B. However, since server B only accepts the access request from web server A (i.e., only the access request sent from the domain name “domain-a.com” is acceptable to the server B) but the domain name of the web server A in the access request has been replaced with “domain-c.com” by the proxy server, server B rejects the access request. Consequently, these contents which need to be obtained from server B are not displayed in the web page loaded by the network terminal device in the public network.

In another scenario, there may be some web authentication protocols which use source/destination domain name as a parameter for authentication. For example, when a user device in the public network accesses the login page provided by a web server A in the private network and inputs his/her account and password on the login page, the web server A sends the user's account and passwords, along with its domain name, to an authentication server, so that the authentication server may identify which web server the user is trying to log into and determine whether the account and password is authorized to access the web server A. However, the authentication server only recognizes the account and password corresponding to the domain name “domain-a.com” but the domain name of the web server A in the authentication request has been replaced with “domain-c.com” by the proxy server, and so the authentication server rejects the authentication request and the login fails.

In yet another scenario, there may be some web programming languages which use domain name to indicate communication destinations. For example, the network terminal device in the public network launches a browser in which a tab window loads a web page al provided by a web server A in the private network and another table window loads a web page b1 provided by a web server B, in which the web page b1 includes a javascript code sending a string ‘hello’ to the tab window of the web page al. However, due to the domain name of web server A having been replaced with “domain-c.com” by the proxy server when the web page al is loaded on the browser, the tab window of the web page al cannot receive the string ‘hello’ from the web page b1.

Therefore, it is desirable to have a cross-communication method that can enable proxy servers to solve the aforementioned problems that can arise during cross-domain communications.

### BRIEF SUMMARY OF THE APPLICATION

In one aspect of the application, a proxy server comprising a communication device and a controller is provided. The communication device is configured to provide network connections to a network terminal device in a public network and a first server and a second server in a private network, wherein the first server has a first domain name identifiable in the private network and a predetermined domain name identifiable in the public network, and the second server has a second domain name identifiable in the private network. When receiving a first web access request from the network terminal device, which indicates that it was sent from the predetermined domain name to the second domain name, the controller is configured to replace the predetermined domain name in the first web access request with the first domain name and forward the first web access request to the second server according to the second domain name in the first web access request. When receiving a first web access response from the second server, which indicates that it was sent from the second domain name to the first domain name, the controller is configured to replace the first domain name with the predetermined domain name in the first web access response and forward the first web access response to the network terminal device.

In another aspect of the application, the cross-domain communication method, executed by a proxy server connected to a network terminal device in a public network and a first server and a second server in a private network, is provided. The first server has a first domain name identifiable in the private network and a predetermined domain name identifiable in the public network, and the second server has a second domain name identifiable in the private network. The cross-domain communication method comprises the following steps: when receiving a first web access request from the network terminal device, which indicates that it was sent from the predetermined domain name to the second domain name, replacing the predetermined domain name in the first web access request with the first domain name and forwarding the first web access request to the second server according to the second domain name in the first web access request, and when receiving a first web access response from the second server, which indicates that it was sent from the second domain name to the first domain name, replacing the first domain name with the predetermined domain name in the first web access response and forwarding the first web access response to the network terminal device.

Other aspects and features of the application will become apparent to those with ordinary skill in the art upon review of the following descriptions of specific embodiments of the proxy servers and the cross-domain communication methods.

### BRIEF DESCRIPTION OF THE DRAWINGS

The application can be more fully understood by reading the subsequent detailed description and examples with references made to the accompanying drawings, wherein:

FIG. 1 is a schematic diagram illustrating the proxy service used in a non-cross-domain communication;

FIG. 2 is a schematic diagram illustrating a network environment according to an embodiment of the application;

FIG. 3 is a block diagram illustrating the system architecture of the proxy server 10 according to an embodiment of the application;

FIG. 4 is a flow chart illustrating the cross-domain communication method according to an embodiment of the application;

FIG. 5 is a schematic diagram illustrating cross-domain communications according to an embodiment of the application;

FIG. 6 is a schematic diagram illustrating cross-domain communications according to another embodiment of the application; and

FIGS. 7A and 7B are schematic diagrams illustrating cross-domain communications according to yet another embodiment of the application.

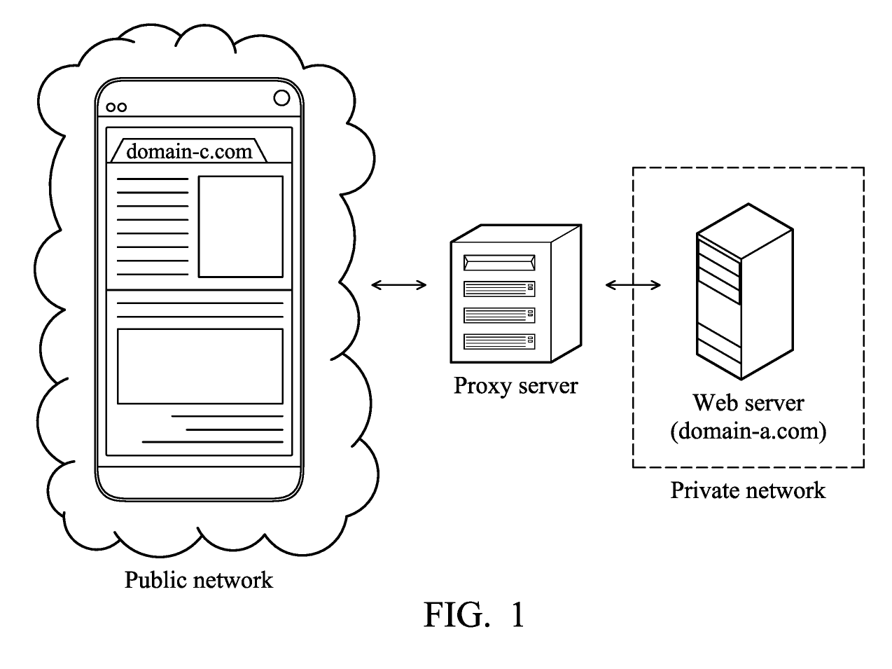

### DETAILED DESCRIPTION OF THE APPLICATION

The following description is made for the purpose of illustrating the general principles of the application and should not be taken in a limiting sense. It should be understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

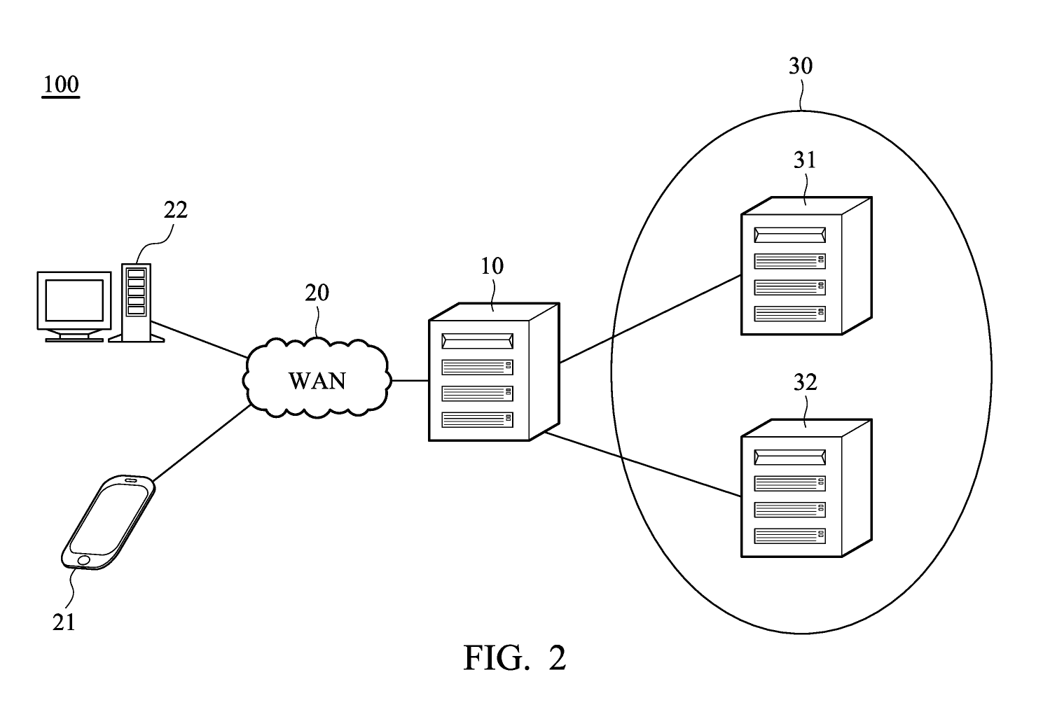

FIG. 2 is a schematic diagram illustrating a network environment according to an embodiment of the application. The network environment 100 includes a proxy server 10, a WAN 20, and a LAN 30, wherein the proxy server 10 is disposed between the WAN 20 and the LAN 30.

The WAN 20 may also be called an external network or a public network, which may include telecommunication network(s), optical network(s), and/or Asymmetric Digital Subscriber Line (ADSL) network(s). The WAN 20 generally spans a wide range: from tens of kilometers to thousands of kilometers. For example, the WAN 20 may cover areas, cities, and/or countries which may be connected via the Internet.

There may be several network terminal devices, such as the network terminal devices 21 and 22, disposed on the WAN 20. Each of the network terminal devices 21 and 22 may be a notebook PC, a desktop computer, a workstation, a server, a smartphone, or panel PC, etc. For example, the network terminal device 21 may be a smartphone for a user to browse the Internet, while the network terminal device 22 may be a Domain Name System (DNS) server for providing the service of domain name resolution.

The LAN 30 may also be called an internal network or a private network, which may include Ethernet(s), twisted-pair cable network(s), and/or coaxial cable networks. The LAN 30 generally covers a small area, such as an office or a floor of a building.

There may be several network communication devices, such as the network communication devices 31 and 32, disposed on the LAN 30. Each of the network communication devices 31 and 32 may be a notebook PC, a desktop computer, a smartphone, a panel PC, a workstation, a server, or any consumer electronic device with a wired/wireless communication function. For example, the network communication device 31 or 32 may be a web server for providing the service of web page hosting, or may be an authentication server for providing the service of user authentication.

The proxy server 10 is responsible for connecting the WAN 20 and the LAN 30 (i.e., acting as a router). In addition, the proxy server 10 provides proxy services to allow the network communication devices 31 and 32 in the LAN 30 to appear anonymous to the WAN 20. That is, the network terminal devices 21 and 22 are unable to directly access the network communication devices 31 and 32, without the proxy server 10 serving as an intermediary.

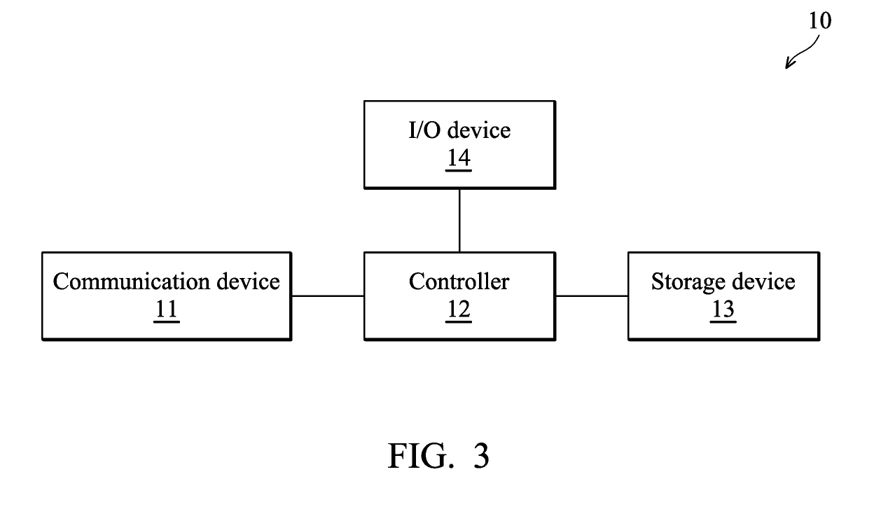

FIG. 3 is a block diagram illustrating the system architecture of the proxy server 10 according to an embodiment of the application. The proxy server 10 includes a communication device 11, a controller 12, a storage device 13, and an Input/Output (I/O) device 14.

The communication device 11 is responsible for providing network connections to the WAN 20 (including the network terminal devices 21 and 22 on the WAN 20) and the LAN 30 (including the network communication device 31 and 32 on the LAN 30). The communication device 11 may provide the network connections using a wired/wireless communication technology, such as the Ethernet technology, Wireless Fidelity (Wi-Fi) technology, Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, or Time-Division LTE (TD-LTE) technology.

In one embodiment, the communication device 11 may include an Ethernet card for providing the function of wired communications. In another embodiment, the communication device 11 may include a wireless transceiver for providing the function of wireless communications, wherein the wireless transceiver may include a baseband device, a Radio Frequency (RF) device, and an antenna. The baseband processing device may contain multiple hardware components to perform baseband signal processing, including Analog-to-Digital Conversion (ADC)/Digital-to-Analog Conversion (DAC), gain adjusting, modulation/demodulation, encoding/decoding, and so on. The RF device may receive RF wireless signals via the antenna, convert the received RF wireless signals into baseband signals, which are processed by the baseband processing device, or receive baseband signals from the baseband processing device and convert the received baseband signals into RF wireless signals, which are later transmitted via the antenna. The RF device may also contain multiple hardware components to perform radio frequency conversion. For example, the RF device may comprise a mixer to multiply the baseband signals with a carrier oscillated in the radio frequency of the supported wireless technologies, wherein the radio frequency may be 2.4 GHz, 3.6 GHz, 4.9 GHz, or 5 GHz utilized in the Wi-Fi technology, or another radio frequency, depending on the wireless technology in use.

The controller 12 may be a general-purpose processor, a Central Processing Unit (CPU), a Micro Control Unit (MCU), an Application Processor (AP), or a Digital Signal Processor (DSP), which includes various circuits for performing the functions of data processing and computing, controlling the communication device 11 to provide network connections, and reading or writing data and/or program code from or to the storage device 13, and receiving user inputs or outputting User Interface (UI) signals via the I/O device 14. In addition, the controller 12 includes other circuits for providing proxy services.

In particular, the controller 12 coordinates the operations of the communication device 11, the storage device 13, and the I/O 14 for performing the cross-domain communication method of the present application.

The storage device 13 is a non-transitory computer-readable storage medium, such as a Random Access Memory (RAM), a flash memory, a cache memory, a hard drive, an optical disc drive, or any combination thereof, which is used for storing computer-executable data, instructions, or program code, including mapping information of domain names, predefined aliases, program code of the cross-domain communication method, and/or program code of an OS, application(s), and/or communication protocol(s).

As will be appreciated by persons skilled in the art, the circuits in the controller 12 will typically include transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in design of electronic and digital systems.

The I/O device 14 may include one or more buttons, light devices, a keyboard, a mouse, a touch pad, a microphone, or a speaker, etc., which serves as a Man-Machine Interface (MMI). For example, a reset signal may be generated when a button is pushed and the reset signal may trigger the controller 12 to perform a reset procedure of the proxy server 10, or a light device may emit lights in different colors to notify the user whether the proxy server 10 functions normally or not.

It should be understood that the components described in the embodiment of FIG. 3 are for illustrative purposes only and are not intended to limit the scope of the application. For example, the proxy server 10 may further include a display device (e.g., a Liquid-Crystal Display (LCD), Light-Emitting Diode (LED) display, or Electronic Paper Display (EPD), etc.), and/or a power supply, etc.

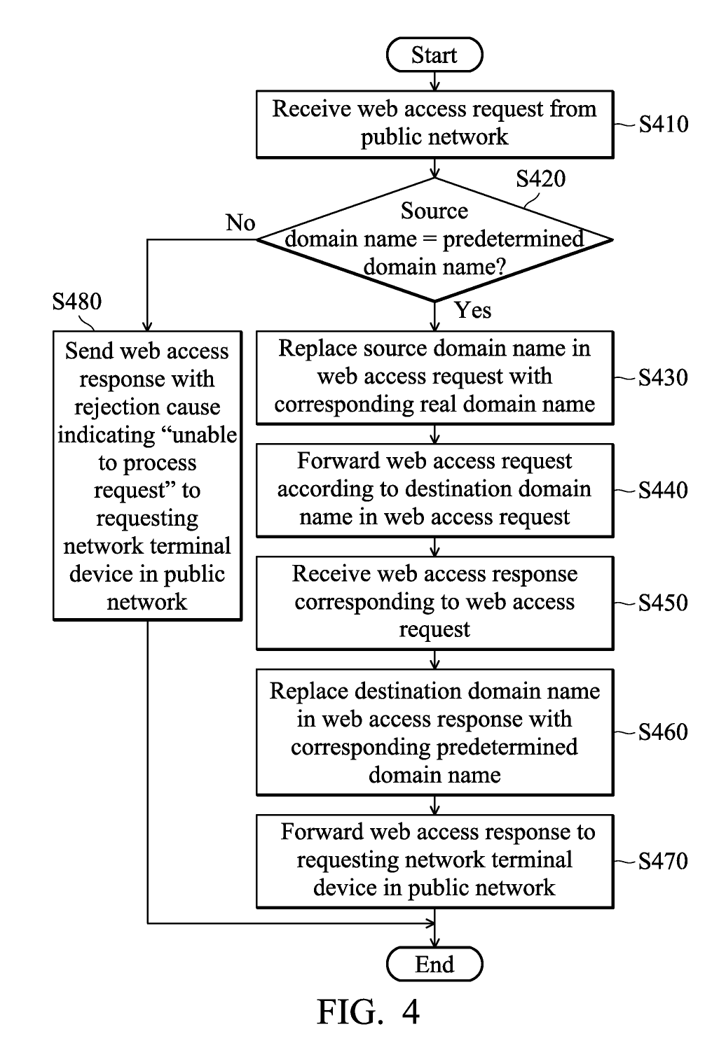

FIG. 4 is a flow chart illustrating the cross-domain communication method according to an embodiment of the application. In this embodiment, the cross-domain communication method is applied to a proxy server, e.g., the proxy server 10.

To begin, the proxy server receives a web access request from the public network (step S410), wherein the web access request indicates that it was sent from a source domain name to a destination domain name. That is, the web access request belongs to cross-domain communications. For example, a web access request is initiated when a web page provided by a web server (e.g., the network communication device 31) in the private network is loaded by a network terminal device (e.g., the network communication device 21) in the public network, but part of the web content needs to be obtained from another web server (e.g., the network communication device 32).

Subsequently, the proxy server determines whether the source domain name indicated in the web access request is a predetermined domain name (step S420). Specifically, the predetermined domain name refers to a virtual domain name of the web server in the private network, which is identifiable in the public network. Each web server in the private network may be configured to have a respective predetermined domain name, and the proxy server may store the mapping information of the real domain name and predetermined domain name of each web server in the private network.

In one embodiment, the web page provided by the web server in the private network may provide a single service, and the predetermined domain name of the web server may be set to a virtual domain name. For example, the real domain name of such a web server (e.g., the network communication device 31) is “domain-a.com” which is identifiable in the private network, and the predetermined domain name of the web server may be set to “domain-c.com”.

In another embodiment, the web page provided by the web server in the private network may provide multiple services, the predetermined domain name of the web server may be set to a virtual domain name, and each service provided in the web page may be assigned with a predetermined domain name being the virtual domain name of the web server plus an alias. For example, the real domain name of such a web server (e.g., the network communication device 31) is “domain-a.com” which is identifiable in the private network, and the real domain names for the services provided in the web page are “mail.domain-a.com”, “docs.domain-a.com”, and “drive.domain-a.com”. The predetermined domain name of the web server may be set to “domain-c.com”, while the predetermined domain name of the services provided in the web page may be set to “alias.domain-c.com”, wherein ‘alias’ may refer to any string, such as ‘mail’, ‘docs’, or ‘drive’, etc. Alternatively, the alias may be attached to the end of the virtual domain name “domain-c.com”. For example, “domain-c.com/alias”.

Each predetermined domain name may further include a port number. For example, “alias.domain-c.com:443” or “domain-c.com:443”.

In addition, the predetermined domain names may be configured and registered to the DNS server(s) (e.g., the network terminal device 22) by the users in the private network or the administrator of the private network. Through the registration, the predetermined domain names (e.g., “domain-c.com”, and “alias.domain-c.com”, etc.) will be bound with the IP address (e.g., 10.11.55.66) of the proxy server and the binding information will be stored in the DNS server(s). After that, when a network terminal device (e.g., the network terminal device 21) in the public network wants to access a web server (e.g., the network communication device 31) in the private network, it sends an inquiry to the DNS server(s) to obtain the IP address (e.g., 10.11.55.66) bounded with the predetermined domain name (e.g., “domain-c.com”, and “alias.domain-c.com”, etc.) of the web server, and then sends the web access request to the proxy server according to the obtained IP address, where the web access request will be processed and forwarded to the web server in the private network. Alternatively, a DNS server may be incorporated into the proxy server to save the network terminal device in the public network from the signaling overhead regarding domain name resolution.

In another embodiment, the proxy server may be configured to provide a web portal. For example, the domain name of the web portal may be set to “vpn.example.com:443” or “login.vpn.example.com:443”. The web portal may further include hyperlinks to multiple web sites. For example, the web portal may include a hyperlink to a web site “service.example.com” in the private network, and the predetermined domain name of the web site may be set to “service.vpn.example.com”, wherein service′ is an alias. Moreover, the web page may include a hyperlink to a web site “patents.google.com” in the public network, and the predetermined domain name of the web site may be set to “googlepatent.vpn.example.com”, wherein ‘googlepatent’ is an alias. Hence, the network communication devices in the private network and the network terminal devices in the public network can all access the web portal at “vpn.example.com:443” or “login.vpn.example.com:443”, and then access any web page in either the private network or the public network via the web portal.

Subsequent to step S420, if the source domain name indicated in the web access request is a predetermined domain name, the proxy server replaces the source domain name in the web access request with the real domain name (e.g., “domain-a.com”) identifiable in the private network (step S430), and then forwards the web access request according to the destination domain name indicated in the web access request (step S440).

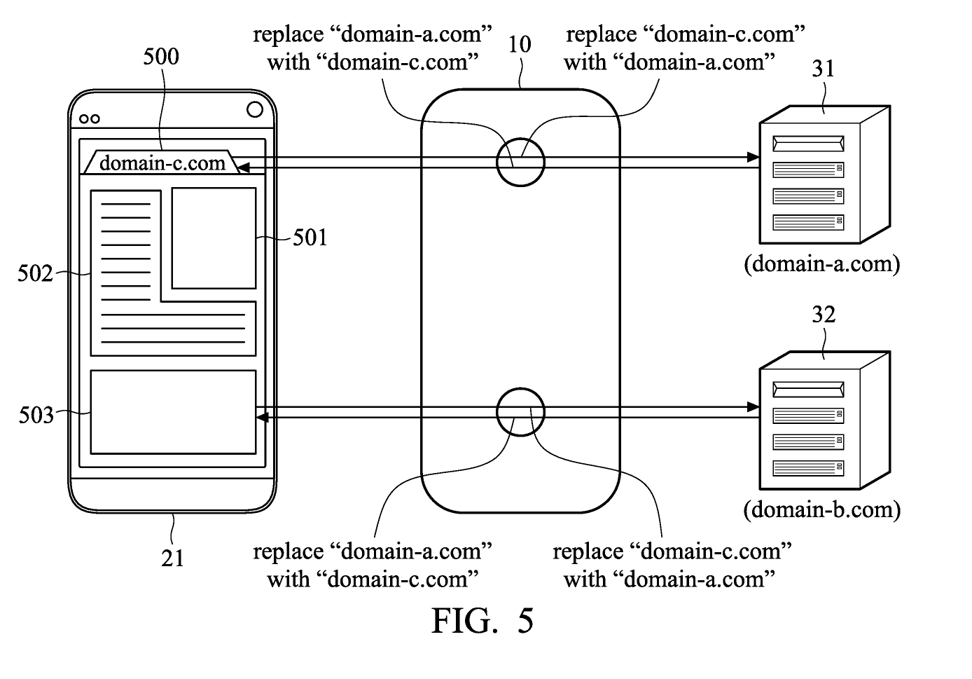

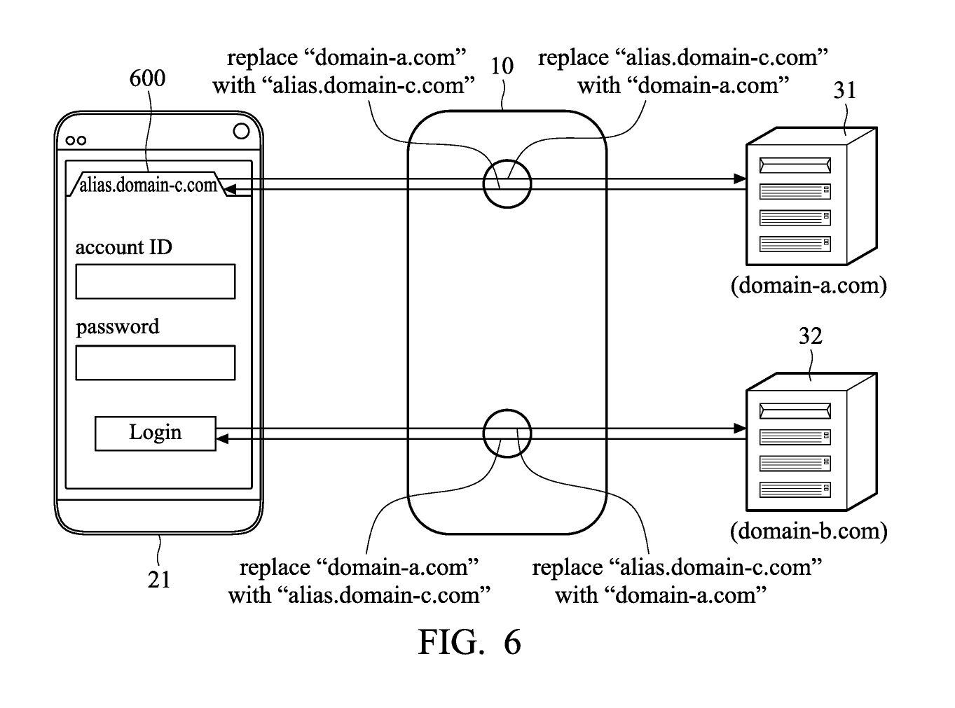

Subsequent to step S440, the proxy server receives a web access response corresponding to the web access request (step S450), wherein the web access response includes information concerning the requested web page, and the header of the web access response indicates that it was sent from the destination domain name (e.g., “domain-b.com”) indicated in the web access request to the real domain name (e.g., “domain-a.com”) corresponding to the source domain name (e.g., “domain-c.com”) indicated in the web access request. Next, the proxy server replaces the destination domain name (e.g., “domain-a.com”) indicated in the web access response with the corresponding predetermined domain name (e.g., “domain-c.com”) (step S460), and forwards the web access response to the network terminal device in the public network, which initiates the web access request (step S470), and the cross-domain communication method ends. Detailed description of parsing the header of the web access response and replacing the domain names is made later in the embodiments of FIGS. 5 and 6.

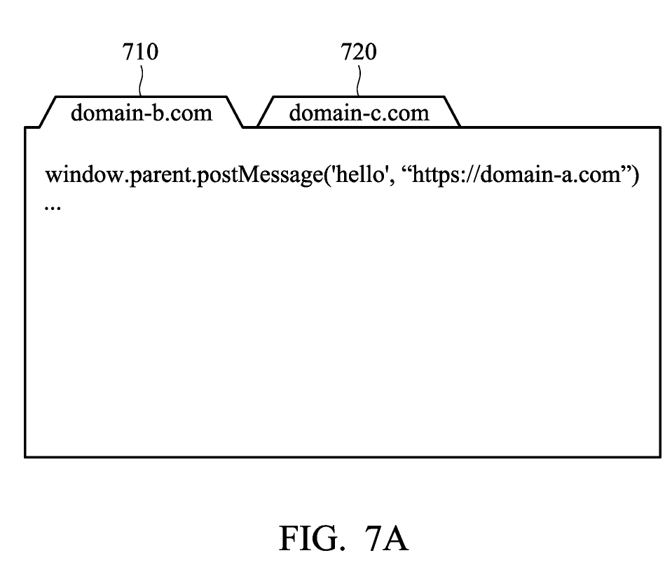

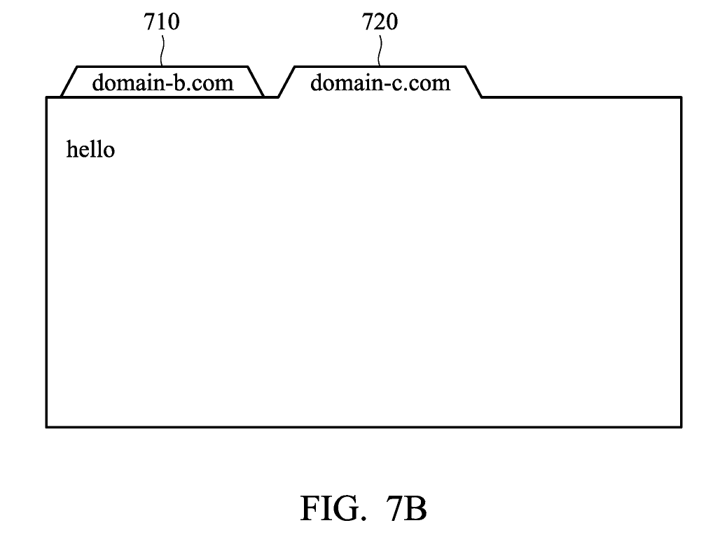

In another embodiment, the proxy server not only parses the header of the web access response to perform the domain name replacement, but also parses the content of the web access response to replace the real domain name indicated in the web access response with the corresponding predetermined domain name. Detailed description of parsing the content of the web access response and replacing the domain names is made later in the embodiment of FIGS. 7A and 7B.

Subsequent to step S420, if the source domain name indicated in the web access request is not a predetermined domain name, the proxy server sends a web access response with a rejection cause indicating “unable to process request” to the requesting network terminal device in the public network (step S480), and the cross-domain communication method ends.

FIG. 5 is a schematic diagram illustrating cross-domain communications according to an embodiment of the application. In this embodiment, the web page 500 provided by the network communication device 31 (i.e., the first web server) in the private network is loaded with a domain name “domain-c.com” by the network terminal device 21 in the public network, and the proxy server 10 replaces the domain name “domain-c.com” with the real domain name “domain-a.com” identifiable in the private network.

As shown in FIG. 5, the domain name “domain-c.com” is displayed in the tab area of the web page 500 due to the real domain name having been replaced by the proxy server 10. The content of the web page 500 includes an image 501, a text 502, and advertisement 503, wherein the image 501 and the text 502 are provided by the first web server in the private network (i.e., the image 501 and the text 502 are already included in the web information provided by the first web server), and the advertisement 503 is to be obtained from the network communication device 32 (i.e., the second web server) in the private network. The network terminal device 21 in the public network loads the web page 500 after receiving the web information of the web page 500 from the first web server in the private network. When loading the web page 500, a web access request to the second web server in the private network is initiated by the content of the web page 500. That is, loading the web page 500 involves cross-domain communication. For example, the web information provided by the first web server may be presented in HyperText Markup Language revision 5 (HTML5) code, the image 501 and the text 502 may be defined by an img element and a font element in the HTML5 code, and the advertisement 503 may be defined by a canvas element in the HTML5 code, as follows.

<canvas id=“clock” width=“150” height=“150”>

<img src=“https://www.domain-
b.com/images/clock.png” width=“150” height=“150”
alt=“”/>

</canvas>

Specifically, the img element defines the image to be displayed in the canvas element, and the src attribute in the img element defines the source of the image to be the second web server (with the domain name “domain-b.com”) in the private network. Therefore, when this part of the web page 500 is loaded, the network terminal device 21 in the public network sends the web access request to the second web server in the private network, wherein the web access request indicates that it was sent from the domain name “domain-c.com” to the domain name “domain-b.com”.

When receiving the web access request, the proxy server 10 replaces the source domain name “domain-c.com” in the web access request with “domain-a.com”, and then forwards the web access request to the second web server in the private network. It should be noted that, in this embodiment, even if the second web server only accepts web access requests from the first web server (i.e., only web access requests indicating that it was sent from the domain name “domain-a.com”), the advertisement 503 can be successfully accessed and displayed due to the proxy server 10 having replaced the source domain name in the web access request with the real domain name of the first web server.

FIG. 6 is a schematic diagram illustrating cross-domain communications according to another embodiment of the application. In this embodiment, the web page 600 provided by the network communication device 31 (i.e., the first web server) in the private network is loaded with a domain name “alias.domain-c.com” by the network terminal device 21 in the public network, and the proxy server 10 replaces the domain name “alias.domain-c.com” with the real domain name “domain-a.com” identifiable in the private network.

As shown in FIG. 6, the domain name “alias.domain-c.com” is displayed in the tab area of the web page 600 due to the real domain name having been replaced by the proxy server 10. The web page 600 is a login page to access the first web server, and when user inputs his/her account and password, the web page 600 further initiates an authentication request to the network communication device 32 (i.e., the second web server) in the private network. Please note that, in this embodiment, the parameters used by the second web server for authentication include the user account, the password, and the source domain name of the authentication request.

Since the source domain name of the authentication request is one of the authentication parameters, the authentication request may fail when a conventional proxy server is used due to the conventional proxy server not replacing the source domain name in the authentication request with the real domain name of the first web server, and the second web server not being able to identify the source domain name (i.e., “alias.domain-c.com”) in the authentication request. Unlike a conventional proxy server, the proxy server 10 replaces the source domain name “alias.domain-c.com” in the authentication request with the real domain name “domain-a.com” of the first web server, so that the authentication request may be successfully processed by the second web server in the private network.

FIGS. 7A and 7B are schematic diagrams illustrating cross-domain communications according to yet another embodiment of the application. In this embodiment, there are two tab windows in the browser, which display the web pages 710 and 720, respectively. The web page 710 provided by the network communication device 32 (i.e., the second web server) in the private network is loaded with a domain name “domain-b.com” by the network terminal device 21 in the public network. The web page 720 provided by the network communication device 31 (i.e., the first web server) in the private network is loaded with a domain name “domain-c.com”by the network terminal device 21 in the public network. The proxy server 10 replaces the domain name (i.e., “domain-c.com”) of the first web server, which is identifiable in the public network, with the real domain name (i.e., “domain-a.com”) identifiable in the private network, for loading the web page 720.

When the network terminal device 21 in the public network requests to access the web page 710 from the second web server in the private network, the proxy server 10 parses the content of the web page 710 provided by the second web server to determine whether the content includes a real domain name corresponding to a preconfigured virtual domain name (i.e., predetermined domain name). If the content includes such a real domain name, the proxy server 10 replaces the real domain name with the corresponding predetermined domain name, and then forwards the information of the web page 710 to the network terminal device 21 in the public network.

As shown in FIG. 7A, a part of the content of the web page 710 initiates sending a message to the tab window of the web page 720. For example, the content may be a javascript code: window.parent.postMessage(‘hello’, “https://domain-a.com”). When the network terminal device 21 is loading the web page 710, the domain name “domain-a.com” in the content will be replaced by the proxy server 10 with “domain-c.com”. After that, when the network terminal device 21 is loading the web page 720, the message sent from the web page 710 can be successfully received and displayed. By contrast, a conventional proxy server does not replace the real domain name in the web content with the corresponding predetermined domain name for cross-domain communications, and the web page 720 cannot receive the message sent from the web page 710.

In one embodiment, the cross-domain communication method of the present application may be implemented in program code as a content parser which is responsible for parsing the headers and contents of the web access requests and responses to replace the domain names therein as described in the embodiments of FIGS. 4 to 7.

In view of the forgoing embodiments of FIGS. 4 to 7, it will be appreciated that the cross-domain communication method of the present application solves the problems regarding provision of proxy services for cross-domain communications, by allowing the proxy server to parse the headers and contents of web access requests and responses and replace the domain names therein. Advantageously, cross-domain communications using proxy services may function successfully.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

Note that use of ordinal terms such as “first”, “second”, etc., in the claims to modify a claim element does not by itself connote any priority, precedence, or order of one claim element over another or the temporal order in which acts of the method are performed, but are used merely as labels to distinguish one claim element having a certain name from another element having the same name (except for use of ordinal terms), to distinguish the claim elements.

What is claimed is:

1. A proxy server, comprising:
a communication device, configured to provide network connections to a network terminal device in a public network and a first server and a second server in a private network,
wherein the first server has a first domain name identifiable in the private network and a predetermined domain name identifiable in the public network, and the second server has a second domain name identifiable in the private network; and
a controller, configured to:
when receiving a first web access request from the network terminal device, which indicates that it was sent from the predetermined domain name to the second domain name, replace the predetermined domain name in the first web access request with the first domain name and forward the first web access request to the second server according to the second domain name in the first web access request, and
when receiving a first web access response from the second server, which indicates that it was sent from the second domain name to the first domain name, replace the first domain name with the predetermined domain name in the first web access response and forward the first web access response to the network terminal device.

2. The proxy server as claimed in claim 1, wherein the controller is further configured to, when receiving a second web access request from the network terminal device, which indicates that it was sent to the predetermined domain name, redirect the second web access request to the first server according to the first domain name and forward information concerning a first web page, which is provided by the first server, to the network terminal device.

3. The proxy server as claimed in claim 2, wherein the first web access request is initiated by content of the first web page when the network terminal device loads the first web page.

4. The proxy server as claimed in claim 2, further comprising:
a Domain Name System (DNS), configured to receive an inquiry for the predetermined domain name from the network terminal device, and reply to the network terminal device with that the predetermine domain name is associated with an Internet Protocol (IP) address of the proxy server;
wherein the second web access request was sent by the network terminal device according to the IP address.

5. The proxy server as claimed in claim 1, wherein the first web access response comprises information concerning a second web page, and the controller is further configured to parse the information concerning the second web page to determine whether a header or content of the information concerning the second web page comprises the first domain name, and when the header or content comprises the first domain name, replace the first domain name with the predetermined domain name in the first web access response and forward the first web access response to the network terminal device.

6. The proxy server as claimed in claim 1, wherein the predetermined domain name comprises a port number.

7. The proxy server as claimed in claim 1, wherein the communication device is further configured to provide a network connection to a third server in the public network, the third server has a third domain name identifiable in the public network and a fourth domain name identifiable in the private network, and the controller is further configured to:
when receiving a third web access request indicating that it was sent to the fourth domain name, replace the fourth domain name in the third web access request with the third domain name and forward the third web access request to the third server according to the third domain name; and
when receiving a third web access response indicating that it was sent from the third domain name, replace the third domain name in the third web access response with the fourth domain name.

8. A cross-domain communication method executed by a proxy server connected to a network terminal device in a public network and a first server and a second server in a private network, wherein the first server has a first domain name identifiable in the private network and a predetermined domain name identifiable in the public network, and the second server has a second domain name identifiable in the private network, the cross-domain communication method comprising:
when receiving a first web access request from the network terminal device, which indicates that it was sent from the predetermined domain name to the second domain name, replacing the predetermined domain name in the first web access request with the first domain name and forwarding the first web access request to the second server according to the second domain name in the first web access request, and
when receiving a first web access response from the second server, which indicates that it was sent from the second domain name to the first domain name, replacing the first domain name with the predetermined domain name in the first web access response and forwarding the first web access response to the network terminal device.

9. The cross-domain communication method as claimed in claim 8, further comprising:
when receiving a second web access request from the network terminal device, which indicates that it was sent to the predetermined domain name, redirecting the second web access request to the first server according to the first domain name and forwarding information concerning a first web page, which is provided by the first server, to the network terminal device.

10. The cross-domain communication method as claimed in claim 9, wherein the first web access request is initiated by content of the first web page when the network terminal device loads the first web page.

11. The cross-domain communication method as claimed in claim 9, further comprising:
providing a Domain Name System (DNS) to receive an inquiry for the predetermined domain name from the network terminal device and reply to the network terminal device with that the predetermine domain name is associated with an Internet Protocol (IP) address of the proxy server;
wherein the second web access request was sent by the network terminal device according to the IP address.

12. The cross-domain communication method as claimed in claim 8, wherein the first web access response comprises information concerning a second web page, and the cross-domain communication method further comprises:
parsing the information concerning the second web page to determine whether a header or content of the information concerning the second web page comprises the first domain name; and
when the header or content comprises the first domain name, replacing the first domain name with the predetermined domain name in the first web access response and forwarding the first web access response to the network terminal device.

13. The cross-domain communication method as claimed in claim 8, wherein the predetermined domain name comprises a port number.

14. The cross-domain communication method as claimed in claim 8, wherein the communication device is further configured to provide a network connection to a third server in the public network, the third server has a third domain name identifiable in the public network and a fourth domain name identifiable in the private network, and the cross-domain communication method further comprises:
when receiving a third web access request indicating that it was sent to the fourth domain name, replacing the fourth domain name in the third web access request with the third domain name and forwarding the third web access request to the third server according to the third domain name; and
when receiving a third web access response indicating that it was sent from the third domain name, replacing the third domain name in the third web access response with the fourth domain name.
